(19) United States
(12) Patent Application Publication
(10) Pub. No.: US 2002/0040344 A1
(43) Pub. Date: Apr. 4, 2002

(54) Check guarantee, verification, processing, credit reports and collection system and method awarding purchase points for usage of checks

(76) Inventors: Randall F. Preiser, Honolulu, HI (US); Kevin Murphy, Honolulu, HI (US)

Correspondence Address: Eugene C. Rzucidlo, Esq., GREENBERG TRAURIG, LLP, 21st Flr., 885 Third Avenue, New York, NY, 10022, US

(21) Appl. No.: 09/956,321

(22) Filed: Sep. 19, 2001

Related U.S. Application Data
(60) Provisional application No. 60/238,104, filed on Oct. 4, 2000.

(51) Int. Cl. G06F 17/60

(52) U.S. Cl. 705/42; 705/40

(57) ABSTRACT

In response to a buyer submitting a check as payment for a transaction with a seller, a check guarantee service determines whether to guarantee the check as payment for the transaction, and offers a membership in the guarantee service to the buyer. Members are issued a user identification number to the buyer and are prompted to select a personal identification number. In subsequent transactions, the member provides his/her user identifier number to the seller for the automatic guaranteeing by the guaranteeing service of the check as payment for the transaction. Members can be awarded points each time the member uses the guaranteeing service to guarantee a check. The points can be converted into digital currency usable for purchasing goods and services.

### CROSS REFERENCE TO RELATED U.S. APPLICATIONS

This application claims priority from Murphy, et al., “Check Guarantee, Verification, Processing, and Collection System Awarding Purchase Points For Usage Of Checks”, U.S. Provisional Application No. 60/238,104, filed Oct. 4, 2000, incorporated herein by reference.

### FIELD OF THE INVENTION

The present invention relates to a method and system for interactive check guarantees from a guarantee service over a computer network or over a telephone connection.

### BACKGROUND OF THE INVENTION

Checks make up the nation's largest non-cash form of payment. It is estimated that approximately 90% of American households use checks to pay for retail purchases, and that over 30% of the transactions completed at the point of sale are paid for with checks. It is also estimated that the average value of retail check sales is almost 20% higher than the average retail sale. In addition, a large fraction of Americans either do not possess a credit card or do not qualify for the issuance of a credit card, and thus for these people checks are the only non-cash alternative for paying for purchases.

Because so many customers and buyers prefer to pay with checks, many sellers and merchants accept checks from their buyers as payment for goods and/or services. Acceptance of checks and other non-cash forms of payment provides a significant convenience for buyers by making it possible to purchase goods and/or services without having to tender cash for each transaction. This eliminates the need to carry large amounts of cash, which is seldom recovered in the event it is lost or stolen. Sellers also benefit by attracting buyers who prefer to shop at stores that accept checks.

Despite its advantages, accepting checks exposes the seller to the risk that the check will be bad, and will not be honored by the buyer's bank. This typically occurs in cases where the account on which the check was drawn has insufficient funds, or if the check had been forged. In most cases where a check is bad, sellers find it difficult, if not impossible, to collect payment or repossess the goods.

In light of the potential losses associated with accepting checks, sellers have sought ways to accurately differentiate between good checks and bad checks. Accuracy is essential because sellers want to reject as many bad checks as possible while also rejecting as few good checks as possible. Due to the nature of a retail environment, a seller's decision to accept or reject a check must be made prior to completion of the transaction, and must be made quickly while buyers wait.

Some smaller sellers may be satisfied with fairly simple precautions. For example, a seller may determine that it is willing to accept checks only from regular buyers who are known to it. This method is obviously of little value for businesses such as grocery and department stores, which typically have a large number of buyers and a relatively large number of cashiers. In settings where buyers are not personally known to the seller, some sellers are willing to accept checks if other criteria are satisfied, such as the check being drawn on a local bank and the buyer presents additional identification.

In order to provide sellers with greater levels of confidence regarding checks presented by buyers, third party vendors offer check acceptance services. In many cases, the check acceptance service actually guarantees the check to the seller based on the response to transaction data transmitted to the check acceptance service. By guaranteeing the check, the check acceptance service buys the check from the seller and assumes the risk of loss if the check is bad.

In order to provide check guarantee services to a seller, the check acceptance service must receive various types of transaction data, including payment data, identification data, and seller data. Payment data usually includes the checking account number, check sequence number, and the amount of the check. Identification data may include the buyer's name, drivers license number, telephone number, etc. The seller data is used by the check acceptance service to determine whether the seller is an active client, and to identify the services provided to the seller. Typically, a retail outlet will have a checkreader that can scan the checking account number and check sequence number from the check itself. The retailer may also have a check imager that can take an electronic image of the check. Once the transaction data is collected at the point of sale, it is transmitted to the check acceptance service.

After the transaction data is received from the seller, the check acceptance service uses the available data to determine the likelihood that the check will be good or bad. This is typically accomplished by searching a database for negative information, such as outstanding bad checks, associated with the buyer's account number or identification data (e.g., drivers license number). In addition, the check acceptance service will search its database for “positive” information accumulated from the check writer's earlier activity. All of this data is analyzed to determine the probability that the current check will be bad.

Although the presently available systems are useful to provide authorization indicia, they include drawbacks that may decrease the seller's ability to efficiently complete sales transactions. For example, the process of scanning and imaging the check takes time, delaying the sales transaction. The authorization procedure also takes time and can potentially miss a bad check. There is also a lack of an effective method whereby, for the buyer, who prefers or only has checks, to purchase goods and services via telephone sales or the internet for the seller to accept a check for payment and have the funds guaranteed. For the foregoing reasons, there is a need in the art for improved methods of guaranteeing checks.

### SUMMARY OF THE INVENTION

The system of the present invention improves upon previous check guaranteeing services by providing buyers with the option of becoming customer members having membership accounts with the check guaranteeing service (“service”). In becoming a customer member, a buyer provides the service with his/her bank account number and authorizes the service to directly access the account in order to make balance inquiries and withdrawals. The customer member in turn receives an unique identifier number (“UIN”) from the service and selects a personal identification number (“PIN”). Sellers and retailers can also become members of the service, and will also have their own merchant identification (“MID”) numbers.

When a customer member wishes to make a purchase via a check at a point-of-sale retail establishment that is also a member, the purchase price and buyer's UIN number along with the seller's ID number are keyed into a keypad, such as a point-of-sale terminal or telephone keypad, for transmission to the service. As an alternative to the UIN, a buyer's bank transit number, account number and check sequence number can be transmitted to the service. Alternatively, each customer buyer could be issued a card with a magnetic stripe or bar code encoding the UIN number such that the number could be read by a card swipe reader. The service then checks the buyer's checking account negative data file and the service's risk management model, and based on the information available decides whether or not to approve the transaction. Assuming there are sufficient funds in the account, the service moves funds from its bank account into the seller's bank account and then requests that the buyer's bank account move funds into the service's account. If there are not sufficient funds in the account, the account is debited a second time and if necessary a third time. If at that time the check has still not cleared, a collection action is initiated.

Customer members can also make purchases over the phone or the web via check using the service. If a seller is a member of the service, the customer member can provide the seller with his/her UIN number or bank transit number, account number and check sequence number over the phone to initiate the transaction, while the web site of a member seller will provide a field for the customer member to enter both the UIN and PIN number.

Another novel aspect of the invention is an incentive program to encourage customer members to use checks as a means of payment. Customer members who sign up for this aspect of the service will receive points each time they use the service to guarantee a check as payment. These points can be redeemed as free or discounted purchases at many sellers who may or may not be participants of the service.

### BRIEF DESCRIPTION OF THE DRAWINGS

FIG. 1 depicts a block diagram of the system components of the present invention.

FIGS. 2A, 2B, and 2C depict a flowchart of a buyer initiating a transaction with a seller.

FIG. 3 depicts a flowchart of how a buyer is offered a membership.

### DETAILED DESCRIPTION OF THE PREFERRED EMBODIMENT

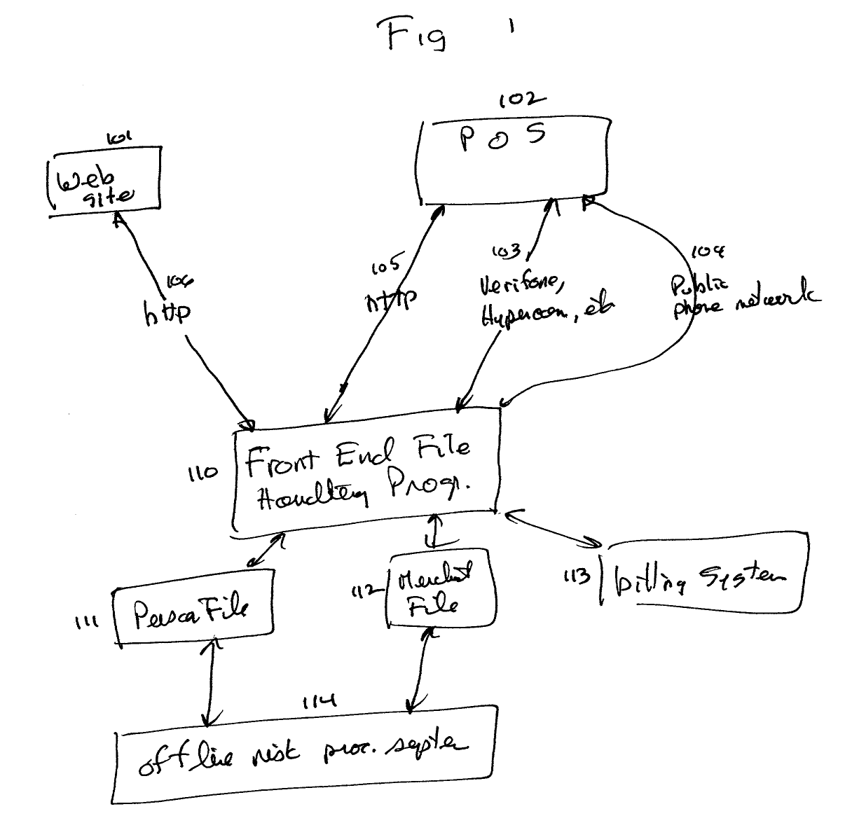

Referring now to FIG. 1, the check guaranteeing system of the invention is accessible to member sellers in several ways. It is an advantage of the present invention that the check guaranteeing system of the invention can use all existing methods currently used by sellers to communicate with check services or credit card processors, and all existing methods by which buyers can communicate with sellers. In one embodiment, the seller can have a cash register or point-of-sale terminal 102 connected to the check guaranteeing service by a connection 103 such as those provided by Verifone or Hypercom. The buyer can either present him/herself at the seller's point-of-sale terminal to proceed with the transaction, or can contact the seller via a telephone connection or via a mail order.

The seller's terminals normally include a check reader that can read the magnetic ink character recognition (“MICR”) characters to obtain the buyer's bank transit number, the buyer's account number, and the check sequence number, and this information is transmitted to the check guaranteeing service. The point-of-sale terminal can optionally include an imager to image the check. This image is stored for later retrieval, if necessary. In an alternative embodiment, there can be a dedicated line connecting a point-of-sale register to the check guaranteeing service via the seller's own in-house computer system. In another embodiment, a seller lacking a terminal or point-of-sale device can contact the check guaranteeing service via a telephone connection 104 and key in required information on the telephone keypad. The check guaranteeing service can also have an automatic voice response unit responsive to vocal transmissions of the required information.

In a preferred embodiment, the seller can contact the check guaranteeing service by accessing the service's web site 101, and then entering the required information via either the computer keyboard or by means of an attached check reader or imager. In another preferred embodiment, the seller maintains a web site through which a buyer can purchase merchandise. The web site of a seller who is a member of the check guaranteeing service can include checks as a payment option and can have a hyperlink to the check guaranteeing service's web site. Once a buyer selects the payment by check option, he/she is redirected to the check guaranteeing service's website, where the required information can be entered. A seller who is contacted by phone by a buyer can process then transaction by either accessing the service's website or by using a point-of-sale terminal. A seller who has received a check as payment for a mail-order transaction can process the check by any of the above methods.

The point of sale terminals or websites all communicate with a front end file handling program 110 maintained by the check guaranteeing service provider. The front end program is in turn connected to other system components, including a person file database 111, a seller file database 112, and a billing system 113. The check guaranteeing system also includes an offline risk processing program 114 that executes periodically and is connected to the person file 111 and the seller file 112.

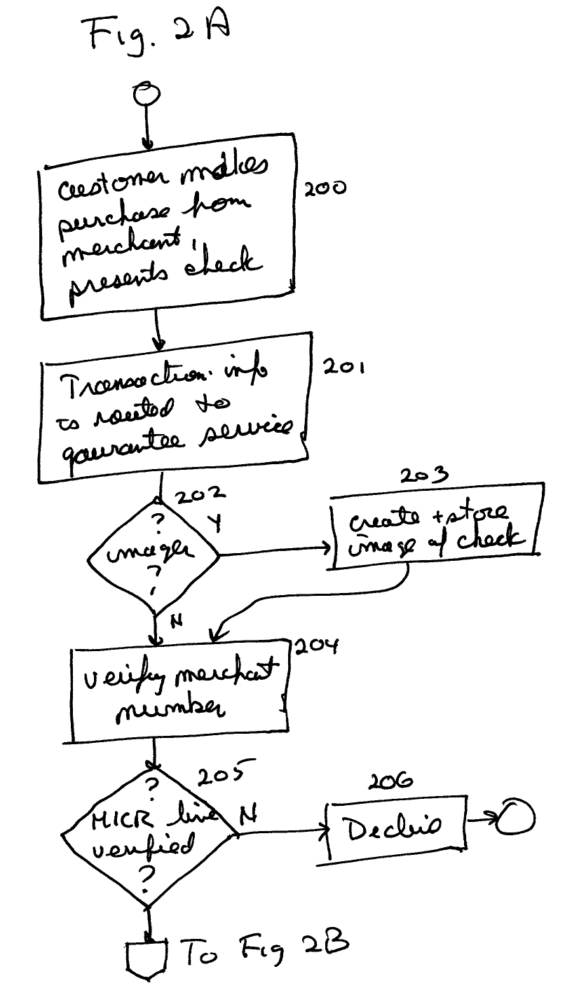

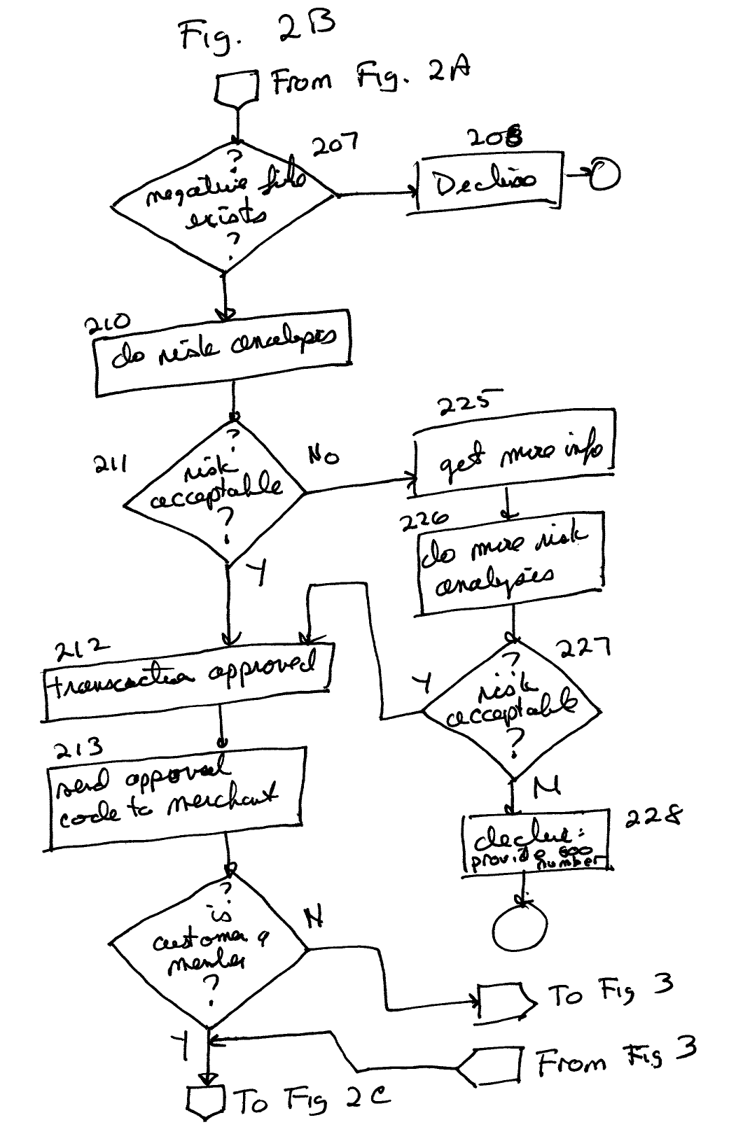

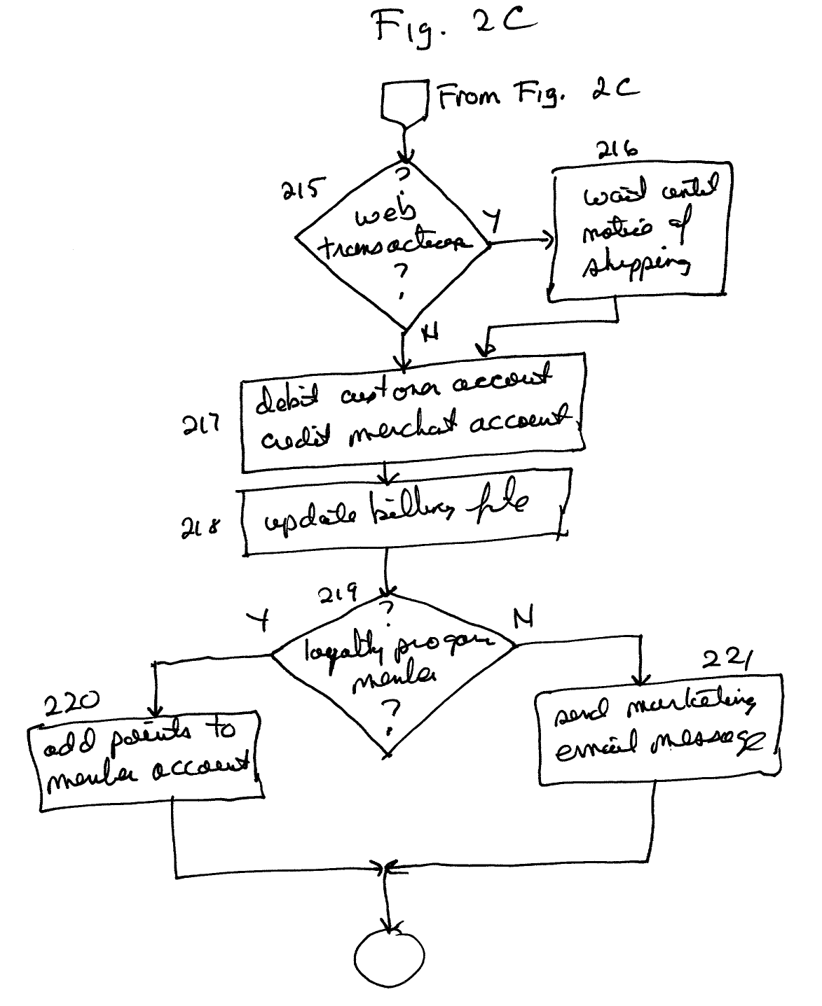

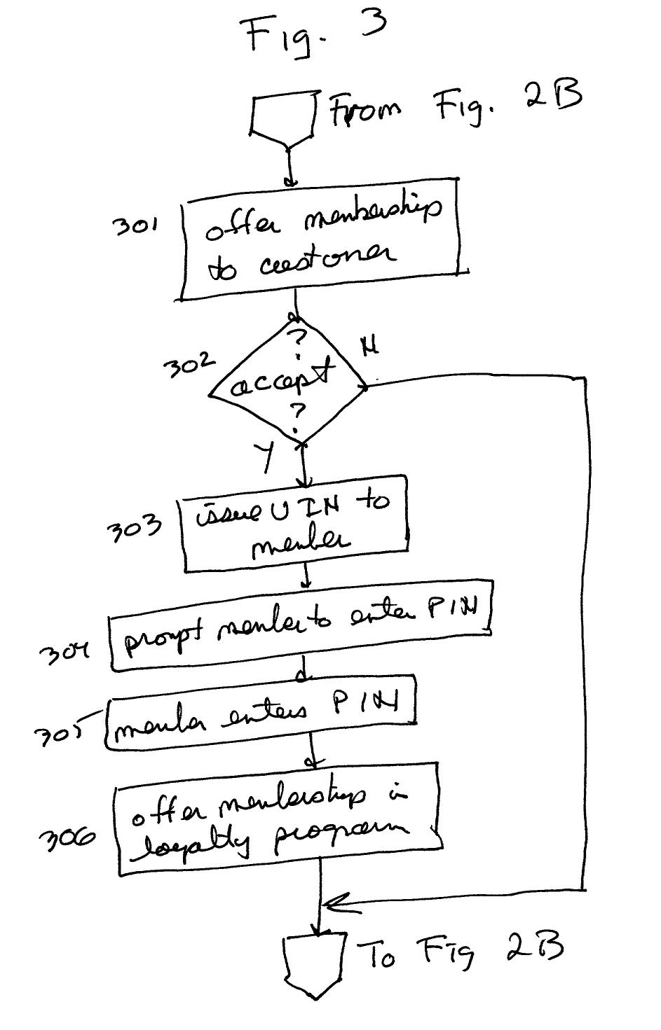

Referring now to FIG. 2A, when a buyer contacts a member seller at step 200 by any of the above referenced methods and wishes to pay for services or goods by check, the check guaranteeing service is contacted at step 201. If an imager is present at step 202, an image of the check is scanned and stored at step 203. The check guaranteeing service then begins its determination as to whether to guarantee the check. The determination of whether to authorize a transaction is performed for both members and non-members. In the case of member, this determination guards against fraud and bad checks.

The authorization determination requires several steps, and is illustrated in FIGS. 2A, 2B and 2C. First, the check guaranteeing service verifies at step 204 the seller's identification. Once the seller has been verified, the check guaranteeing service verifies at step 205 the buyer's bank transit number, the buyer's account number, and the check sequence number. If any of these numbers is invalid, the transaction is declined at step 206. Next, the check guaranteeing service checks at step 207 its own databases and optionally one or more commercially available databases to see if the buyer has a negative credit record. One such database is that maintained by Rocky Mountain Retail Systems. If such a negative file exists, the check guaranteeing service can decline the transaction at step 208.

Other databases can also be referenced during the approval process. These databases can include, for example, a positive credit databases, which are useful in fraud detection, a service member database, various bank databases, telephone number databases, and databases of previous transaction.

Next, the check guaranteeing service performs at step 210 a risk analysis on the impending transaction to calculate a transaction risk score. Factors evaluated in the risk analysis include the transaction amount, the seller's guarantee limit, a velocity factor based on when the last transaction occurred between the seller and buyer, a dollar volume risk factor, and the maximum acceptable risk for that seller. Methods of performing risk analysis are well known in the art. The check guaranteeing service makes at step 211 an initial determination as to whether the transaction risk score represents an acceptable risk. If the transaction risk score is determined to represent an acceptable risk, the transaction is approved at step 212, otherwise additional information is requested from the buyer at step 225, as explained below.

Another factor used in assessing the risk associated with a transaction is to query the buyer's bank account balance. Currently, an account query must be performed over the phone and cannot be done automatically. However, for large transactions being conducted over the Internet, an account query can be performed.

Once a transaction has been approved, the check guaranteeing service sends at step 213 an approval code to the seller. The check guaranteeing service then determines if the buyer is a member at step 214. If not, the buyer who is not a member is offered at step 301 in FIG. 4 a chance to become a customer member of the check guaranteeing service. A buyer who is already a customer member can also apply for another membership account. If the buyer accepts the offer at step 302, he/she is issued a unique identifier number (“UIN”) at step 303. In a preferred embodiment, the UIN is a 16 digit number. Once the UIN has been issued, the customer member can change the UIN to any other number. In a preferred embodiment, this number has from 9 to 16 digits. If the number selected by the customer member has less than 16 digits, the service pads the number out to 16 digits with zeros. In addition, the buyer can be prompted to select a personal identification number (“PIN”) at step 304, who enters the PIN at step 305. In a preferred embodiment, the PIN is a four digit number. The PIN number is known only to the customer member who selected it, and secured by encryption within the service's computer systems.

For any future transaction with a member seller, the customer member provides his/her name and UIN when the check guaranteeing service is contacted. For some transactions, a customer member will be prompted to enter the PIN number to guard against fraud and over use. These transactions include web-based transactions and transactions involving large amount of money. The new member can also be issued a member card with the member's name, UIN and PIN encoded on the card. The encoding can be a magnetic stripe or it could be a barcode that is optically scanned. The member can then present this card to a seller to be swiped through a card reader in order for the transaction to be guaranteed.

Another aspect of the invention is rewarding customer members for writing checks via the check guaranteeing service, an aspect referred to as the incentives program. Thus, once a buyer has accepted membership in the check guaranteeing service, he or she is offered a membership in the incentives program at step 306. A customer member who is a member of the incentives program can automatically receive points in the form of a digital currency every time the check guaranteeing service is used to authorize a transaction. One example of a digital currency redeemable for merchandise, frequent flyer miles, hotel stays, and car rentals is Netcentives™ ClickRewards™ program. Thus, the customer member who accepts membership in the incentives program is awarded points for having used a check to pay for the current transaction.

Customer members can check their points by simply logging onto the check guaranteeing service's web site and using their PINs to navigate to a points page. If, however, a customer member presents a check to the check guaranteeing service that is returned unpaid by the buyer's bank, the buyer's reward points are suspended until the debt to the check guaranteeing service is cleared.

The check guaranteeing service's server is completely secure and customer member account information is not shared with sellers.

Referring now to FIG. 2C, once a transaction is approved, the check guaranteeing service will finish processing the transaction. If, however, the transaction is determined to be a web-based transaction at step 215, the check guaranteeing service wait until notification of shipping at step 216 before completing the transaction. Then, at step 217, the check guaranteeing service debits the buyer's bank account and credits the seller's bank account for the amount of the transaction via its own account, and updates its billing file at step 218. The seller's account is credited via an electronic funds transfer (“EFT”). Alternatively, if the seller has a check imager, the paper check can be converted into an EFT, and the amount of the transaction is debited from the buyer's bank account to the check guaranteeing service's account and the check guaranteeing service credits the seller's account for the amount, both by an EFT. In this situation, the buyer does not need to actually write a check. Internet and telephone transactions are processed via EFTs. In these cases, the transaction is completed when the product is shipped. The service can notify the buyer by email when the transaction is approved and when the product is shipped. If the check is returned unpaid, the seller can make a claim to the service, which then deposits the amount of the check in the seller's account.

Next, the service determines at step 219 whether the buyer is a member who is also an loyalty program member. If so, points are added to the member's point total at step 220, otherwise the check guaranteeing service sends a marketing email message to the non-member at step 221.

Returning to step 225 of FIG. 2B, if the transaction risk score is determined to represent an unacceptable risk, the check guaranteeing service continues the risk analysis at step 226 by requesting additional information about the buyer from the seller. One item of information that can be requested of the buyer at step 601 is the buyer's full telephone number, including the area code. The buyer's telephone can be called by a computer to verify that the number is connected and in service, by detecting a ring or a busy signal. The check guaranteeing service can also verify that the buyer's bank account is active by depositing a small amount of money, for example $0.01, in the account. The risk analysis continues by re-evaluating transaction risk score based on whether the buyer's telephone is in service, by comparing the buyer's area code against that of the seller to determination a state location risk, and by whether the buyer's account is active. If the revised transaction risk score is then deemed to represent an acceptable risk at step 227, the transaction is approved. Otherwise, the transaction is declined at step 228 the buyer is provided with an 800 telephone number that can be used to inquire as to the reasons for the transaction being declined.

Another aspect of the system of the invention is an offline risk program that is run periodically by the check guaranteeing service provider. The risk management system utilizes tables of risk parameters. This program analyzes recent buyer-seller activity and re-evaluates seller risk, transaction risk and buyer risk and can update risk parameter tables. These tables include the velocity table, the dollar volume table and the supplemental information risk table. These tables are illustrative, and more or fewer tables can be utilized in the risk analysis. Among the factors analyzed in re-evaluating the tables are the buyer account velocity, seller type, seller location, seller claim history, seller guarantee limit, goods sold, bank branch location, bank velocity, and bank branch velocity. This list is illustrative, and more or fewer factors can be considered. In a preferred embodiment, the offline risk program is run at least every 5 minutes.

The system of the invention can be implemented on any networked computer system. In one embodiment, the system is implemented in a set of Java programs running on a Sun Solaris platform that use an Oracle database management program, with the offline processing running under VAX/VMS. However, the system could easily be implemented on a Windows 200/NT platform, and any database management system compatible with that platform can be used. In addition, the offline processing can be run on any computer with sufficient processing power.

The system of the invention is not limited to the embodiments disclosed herein. It will be immediately apparent to those skilled in the art that variations and modifications to the disclosed embodiment are possible without departing from the spirit and scope of the present invention. The invention is defined by the appended claims.

What is claimed is:

1. A method of guaranteeing a check presented as payment for a transaction involving a buyer purchasing goods or services from a seller, said method comprising the steps of:
verifying by a check guarantee service a buyer's bank transit number and bank account number of the check presented;
determining by the check guarantee service if a negative file exists for the buyer;
calculating a transaction risk score that is a measure of a risk involved with the transaction;
determining whether the transaction risk score represents an acceptable risk for the seller with respect to the transaction;
guaranteeing the check as payment for the transaction in the event the risk is acceptable to the seller;
offering to the buyer an option to be a customer member in the check guarantee service;
issuing a user identification number to the customer member in response to the buyer accepting a membership in the check guarantee service; and
offering the customer member a membership in a loyalty program of the check guarantee service.

2. The method of claim 1, further comprising the step of allowing the customer member to change the user identification number.

3. The method of claim 2, further comprising the steps of prompting the customer member to select a personal identification number, and
in response to the prompt, the customer member selecting the personal identification number.

4. The method of claim 3, further comprising the step of issuing the customer member a card encoded with the customer member's name, user identification number and personal identification number, wherein the customer member's name and identification can be provided to the seller by reading information encoded in the card.

5. The method of claim 4, wherein the customer member's name, user identification number and personal identification number are encoded in a magnetic strip on the card.

6. The method of claim 4, wherein the customer member's name, user identification number and personal identification number are encoded in an optically readable barcode on the card.

7. The method of claim 1, wherein the step of calculating a transaction risk score includes evaluating a transaction amount, a guarantee limit for the seller, a velocity risk, a dollar volume risk, the seller's claim history, the goods or services being purchased, the seller's location, and the buyer's bank location.

8. The method of claim 1, further comprising the step of, in response to determining the transaction risk score to represent an unacceptable risk to the seller, obtaining additional information from the buyer, including the buyer's full 10 digit telephone number, and further comprising the steps of:
dialing the buyer's telephone number to confirm that it is in service and not disconnected;
re-calculating the transaction risk score based on additional factors including the buyer's area code, the seller's area code, and whether the buyer's telephone is in service; and
re-evaluating whether the transaction risk score represents an acceptable risk to the seller with respect to the transaction.

9. The method of claim 8, further comprising the step of verifying the buyer's bank account by depositing a small sum into said buyer bank account.

10. The method of claim 1, further comprising the steps of the check guarantee service using an electronic transfer to debit the buyer's bank account for the amount of the check, and to credit the seller's account for the amount of the check.

11. The method of claim 1, further comprising the step of, for a customer member who is a member of the loyalty program, awarding points to the member each time the customer member uses the check guarantee service to guarantee a check presented as payment for a commercial transaction, wherein the points can be converted into digital currency redeemable for purchasing goods and services.

12. The method of claim 11, further comprising the step of suspending the members points if a member's check is returned unpaid, said suspension to be in effect until the debt to the check guaranteeing service is paid.

13. The method of claim 1, wherein the seller maintains a web site and the transaction occurs over the world wide web.

14. The method of claim 1, wherein the transaction occurs at a point-of-sale terminal.

15. The method of claim 1, wherein the transaction occurs during a telephone call.

16. A method of guaranteeing a check presented as payment for a transaction involving a buyer purchasing goods or services from a seller, said buyer being a customer member of a check guaranteeing service, said method comprising the steps of:
the customer member providing a user identification number to the seller; and
the seller providing the user identification number to the check guarantee service for the guaranteeing of the check presented as payment for the transaction.

17. The method of claim 16, further comprising the step of the customer member providing a personal identification number to the seller.

18. The method of claim 17, wherein the user identification number and personal identification number provided to the seller are encoded on a card issued to the customer member by the check guaranteeing service.

19. The method of claim 18, wherein the user identification number and personal identification number are encoded in a magnetic strip on the card.

20. The method of claim 18, wherein the user identification number and personal identification number are encoded in an optically readable barcode on the card.

21. The method of claim 16, further comprising the steps of the check guarantee service using an electronic transfer to debit the buyer's bank account for the amount of the check, and to credit the seller's account for the amount of the check.

22. The method of claim 16, further comprising the step of, for a customer member who is a member of the loyalty program, awarding points to the member each time the customer member uses the check guarantee service to guarantee a check presented as payment for a commercial transaction, wherein the points can be converted into digital currency redeemable for purchasing goods and services.

23. The method of claim 22, further comprising the step of suspending the members points if a member's check is returned unpaid, said suspension to be in effect until the debt to the check guaranteeing service is paid.

24. The method of claim 16, wherein the seller maintains a web site and the transaction occurs over the world wide web.

25. The method of claim 16, wherein the transaction occurs at a point-of-sale terminal.

26. The method of claim 16, wherein the transaction occurs during a telephone call.

27. A system of guaranteeing a check presented as payment for a transaction involving a buyer purchasing goods or services from a seller, said system comprising:
means for a check guarantee service to verify a buyer's bank transit number and bank account number of the check presented;
means for the check guarantee service to determine if a negative file exists for the buyer;
means for calculating a transaction risk score that is a measure of the risk involved with the transaction;
means for determining whether the transaction risk score represents an acceptable risk to the seller with respect to the transaction;
means for guaranteeing the check as payment for the transaction in the event of acceptable risk to the seller;
means for offering the buyer the option to be a customer member the check guarantee service;
means for issuing a user identification number to the customer member, in response to the buyer accepting a membership in the guarantee service; and
means for offering the customer member a membership in a loyalty program of the check guaranteeing service.

28. The system of claim 27, further comprising means for allowing the customer member to change the user identification number.

29. The system of claim 28, further comprising means for prompting the customer member to select a personal identification number, and
means for the customer member to select the personal identification number, in response to the prompt.

30. The system of claim 29, further comprising means for issuing the customer member a card encoded with the customer member's name, user identification number and personal identification number, wherein the customer member's name and identification can be provided to the seller by reading information encoded in the card.

31. The system of claim 30, wherein the customer member's name, user identification number and personal identification number are encoded in a magnetic strip on the card.

32. The system of claim 30, wherein the customer member's name, user identification number and personal identification number are encoded in an optically readable barcode on the card.

33. The system of claim 27, wherein the means for calculating a transaction risk score includes means for evaluating a transaction amount, a guarantee limit for the seller, a velocity risk, a dollar volume risk, the seller's claim history, the goods or services being purchased, the seller's location, the buyer's bank location, and a maximum acceptable risk for said seller.

34. The system of claim 27, further comprising means for obtaining, in response to determining the transaction risk score to represent an unacceptable risk to the seller, additional information from the buyer, including the buyer's full 10 digit telephone number, and further comprising:
means for dialing the buyer's telephone number to confirm that it is in service and not disconnected;
means for re-calculating the transaction risk score based on additional factors including the buyer's area code, the seller's area code, and whether the buyer's telephone is in service; and
means for re-evaluating whether the transaction risk score represents an acceptable risk to the seller with respect to the transaction.

35. The system of claim 34, further comprising means for depositing a small sum into said buyer bank account, in order to verify the buyer's bank account.

36. The system of claim 27, further comprising means for the check guarantee service use an electronic funds transfer to debit the buyer's bank account for the amount of the check, and to credit the seller's bank account for the amount of the check.

37. The system of claim 1, further comprising for awarding points to the customer member who is a member of the loyalty program, each time the customer member uses the check guarantee service to guarantee a check presented as payment for a commercial transaction, wherein the points can be converted into digital currency redeemable for purchasing goods and services.

38. The system of claim 37, further comprising means for suspending the customer member's points if the customer member's check is returned unpaid, said suspension to be in effect until the debt to the check guaranteeing service is paid.

39. The system of claim 27, wherein the seller maintains a web site and the transaction occurs over the world wide web.

40. The system of claim 27, wherein the transaction occurs at a point-of-sale terminal.

41. The system of claim 27, wherein the transaction occurs during a telephone call.

42. A system for guaranteeing a check presented as payment for a transaction involving a buyer purchasing goods or services from a seller, said buyer being a customer member of a check guaranteeing service, said system comprising:
means for the customer member to provide a user identification number to the seller; and
means for the seller to provide the user identification number to the check guaranteeing service for guaranteeing the check presented as payment for the transaction.

43. The system of claim 42, further comprising means for the customer member to provide a personal identification number to the seller.

44. The system of claim 43, wherein the user identification number and personal identification number provided to the seller are encoded on a card issued to the customer member by the check guaranteeing service.

45. The system of claim 44, wherein the user identification number and personal identification number are encoded in a magnetic strip on the card.

46. The system of claim 45, wherein the user identification number and personal identification number are encoded in an optically readable barcode on the card.

47. The system of claim 42, further comprising means for the check guarantee service to use an electronic funds transfer to debit the buyer's bank account for the amount of the check, and to credit the seller's account for the amount of the check.

48. The system of claim 42, further comprising means, for a customer member who is a member of the loyalty program, for awarding points to the customer member each time the customer member uses the check guarantee service to guarantee a check presented as payment for a commercial transaction, wherein the points can be converted into digital currency redeemable for purchasing goods and services.

49. The system of claim 48, further comprising means for suspending the customer member's points if a customer member's check is returned unpaid, said suspension to be in effect until the debt to the check guaranteeing service is paid.

50. The system of claim 42, wherein the seller maintains a web site and the transaction occurs over the world wide web.

51. The system of claim 42, wherein the transaction occurs at a point-of-sale terminal.

52. The system of claim 42, wherein the transaction occurs during a telephone call.
